(19) United States
(12) Patent Application Publication
(10) Pub. No.: US 2008/0248302 A1
(43) Pub. Date: Oct. 9, 2008

(54) Rod Member and Method for Producing the Same

(75) Inventor: Sang Keun Lee, Seoul (KR)

Correspondence Address: BIRCH STEWART KOLASCH & BIRCH, PO BOX 747, FALLS CHURCH, VA, 22040-0747, US

(73) Assignee: RE-FORM SYSTEM CO., LTD., SEOUL,KOREA (KR)

(21) Appl. No.: 10/586,535

(22) PCT Filed: Jan. 19, 2005
(86) PCT No.: PCT/KR05/00169

§ 371 Date: Jul. 19, 2006

(30) Foreign Application Priority Data
Jan. 19, 2004 (KR) 10-2004-0003724

(51) Int. Cl. B32B 5/02; B05D 1/36

(52) U.S. Cl. 428/378; 427/407.1; 427/407.2

(57) ABSTRACT

A rod member includes a rod-shaped reinforcing layer formed of a fiber, a resin layer formed on an outer circumference of the reinforcing layer, and a garnet layer formed in/on the resin layer.

### TECHNICAL FIELD

The present invention relates to a rod member and a method for making the same, and more particularly, to a rod member and a method for making the same, which can improve the binding strength of the rod member with cement mortal by forming a garnet on an outer circumference of the rod and making the rod using a fiber and resin.

### BACKGROUND ART

A ferroconcrete structure or concrete structure may be easily damaged by exfoliation, cracking and the like, thereby causing the collapse of the building due to the deteriorated compressive/tension strength.

As the concrete has about pH 12.5, it is designed to prevent the reinforcing rod from being corroded.

However, as carbonic acid gas, an acidoid and chlorine may be permeated into the ferroconcrete structure or the aggregate may cause the alkaline reaction. This may generate the rust on the reinforcing rod. Furthermore, the ferroconcrete structure may be affected by the weather condition. That is, the ferroconcrete may be neutralized according to the weather condition, causing the generation of the rust-on the reinforcing rod.

In addition, when the aggregate mixed with the ferroconcrete is formed of volcanic rocks, the neutralization of the ferroconcrete may be accelerated.

When the rod is rusted, the concrete structure may be cracked by the swelling of the rust. As a result, the ferroconcrete structure may be damaged.

In order to remedy the damage of the ferroconcrete or concrete structure, cement mortal, concrete, epoxy resin and the like have been used. However, since the remedy material is not completely integrated with the original structure, the remedy effect is disappeared after a predetermined time has lapsed.

As such a remedy material, fiber reinforced plastic (FRB) may be exampled. The FRB is formed of low pressure casting thermosetting resin with glass fiber as a reinforcing material, which has a low elastic coefficient. Therefore, it is difficult to apply the FRB to an application where a relatively high rigidity is required. Furthermore, the FRB has low binding strength on a wet surface.

Furthermore, grout composition may be used as the remedy material. Particularly, it is used to a structure where the reinforced rods are exposed by the exfoliation of the concrete or the lack of the covering. Particularly, the grout composition with concrete binder is designed not to contract but have low binding force. However, this grout composition cannot be used when the work is performed in the water.

In recent years, a variety of structure aid materials such as a water-proof material, a transparent brightener, a sliding protective material, a docking material, a rust treating material has been used to reinforce or remedy the ferroconcrete or steel structure.

However, such materials are expensive and complicate in application to the structure, increasing the construction costs.

Accordingly, as a maintenance/remedy material for concreter buildings, concrete tunnel structures, concrete bridge structures, concrete harbor structures, concrete dam structures, and the like, the ferroconcrete has been widely used.

However, as described above, since the ferroconcrete has a problem in that the rod may be easily rusted. Furthermore, since the ferroconcrete is heavy, it is difficult to transfer the same. Particularly, when the structure should be constructed in water or wet area, since the rods are easily rusted, the strength of the structure is quickly weakened.

### DISCLOSURE

An object of the present invention is to provide a rod member that can be easily maintained and remedied with less expense when the ferroconcrete or concrete structure is damaged and to provide a method of making such a rod member.

Another object of the present invention is to provide a rod member that can be used in place of or together with an iron rod member during the construction of a ferroconcrete structure and to provide a method of making such a rod member.

Still another object of the present invention is to provide a rod member that is designed not to be rusted so that it can be used for a concrete structure in water or wet area.

Still another object of the present invention is to provide a rod member that is light in weight so that it is easy to convey the rod member and to construct a structure.

To achieve these and other advantages and in accordance with the purpose of the present invention, as embodied and broadly described, there is provided a rod member comprising a rod-shaped reinforcing layer formed of a fiber; a resin layer formed on an outer circumference of the reinforcing layer; and a garnet layer formed in/on the resin layer.

According to another aspect of the present invention, there is provided a rod member comprising a rod having a reinforcing member formed of an aramid fiber and a resin layer formed on an outer circumference of the reinforcing member; and a garnet layer formed on an outer circumference of the rod, wherein the garnet layer is formed with a plurality of garnets, some of the garnets being mixed in the resin layer and rest of the garnets being protruded above the resin layer.

According to still another aspect of the present invention, there is provided a method for making a rod member, comprising the steps of forming a reinforcing member using a fiber; forming a resin layer on an outer circumference of the reinforcing member to define a rod with the reinforcing member; and forming a garnet layer on an outer circumference of the resin layer through first and second garnet spraying processes.

### DESCRIPTION OF DRAWINGS

FIG. 1 is a perspective view of a rod member according to an embodiment of the present invention;

FIG. 2 is a sectional view of a rod member depicted in FIG. 1;

FIGS. 3A through 3C are sectional views illustrating a process for forming a garnet layer of a rod member according to an embodiment of the present invention;

FIG. 4 is a view illustrating a using state of a rod member according to an embodiment of the present invention; and

FIG. 5 is a view illustrating a state where a rod member of the present invention is applied to a structure.

### BEST MODE FOR CARRYING OUT THE INVENTION

Hereinafter, preferred embodiments of the present invention will be described in detail with reference to accompanying drawings.

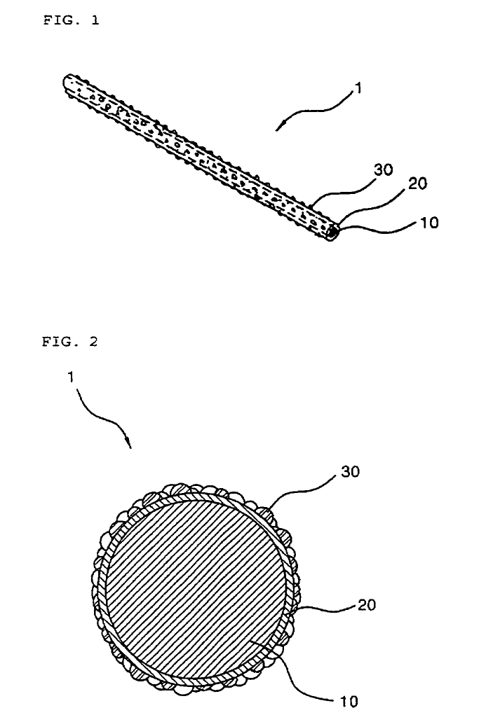

FIG. 1 is a perspective view of a rod member according to an embodiment of the present invention and FIG. 2 is a sectional view of a rod member depicted in FIG. 1.

Referring to FIGS. 1 and 2, the inventive rod member 1 includes a reinforcing layer 10, a resin layer 20 and a garnet layer 30.

That is, the reinforcing layer 10 is formed in a rod-shape using a material selected from the group consisting of a carbon fiber, a glass fiber, and an aramid fiber.

The carbon fiber has a relatively high elastic coefficient. However, since the carbon fiber has a small stress, it has a problem that it has a high brittleness when it is cut. The fiber glass has a problem that it has a relatively low rigidity and elastic coefficient. The aramid fiber has a proper rigidity and elastic coefficient.

Therefore, it is preferable that the reinforcing member 10 is formed of the aramid fiber.

The resin layer 20 is formed on an outer surface of the reinforcing layer 10. The resin layer 20 may be formed of a material selected from the group consisting of epoxy resin, acryl resin, and polyvinyl ester resin. Since the polyvinyl ester resin has an advantage of having a high elongation ratio and a short hardening time, when it is applied to a structure, the elongation effect can be obtained. Furthermore, the short hardening time increases the productivity.

Therefore, it is preferable that the resin layer is 20 is formed of the polyvinyl ester resin.

Here, it is very important to maintain a predetermined thickness ratio between the reinforcing layer 10 and the resin layer. For example, when a thickness of the resin layer 20 is too big compared with that of the reinforcing layer 10, the brittleness is deteriorated while the weight of the rod is increased. Furthermore, air bubbles are generated, thereby deteriorating the productivity.

Therefore, it is preferable that a rod comprised of the reinforcing layer 10 and the resin layer 20 is formed such that the reinforcing layer 10 has 60-80 Wt % while the resin layer 20 has 20-40 Wt %.

More preferably, the reinforcing layer 10 has 70 Wt % while the resin layer 20 has 30 Wt %.

The garnet layer 30 has a plurality of garnets attached on the resin layer 20 of the rod. The garnets are designed to have a different thickness. By the garnet layer 30, the binding force of the rod member 1 with the mortal can be maximized.

The garnet is a generic term of the silicate mineral. Each garnet is designed having 300-800 μm.

The formation of the garnet layer 30 is very important feature in the rod member and the method for making the same according to the present invention.

That is, by forming the garnet layer 20 on the rod composed of the reinforcing member 10 and the resin layer 20, the rod member 1 may have a surface structure having a high binding property in the concrete.

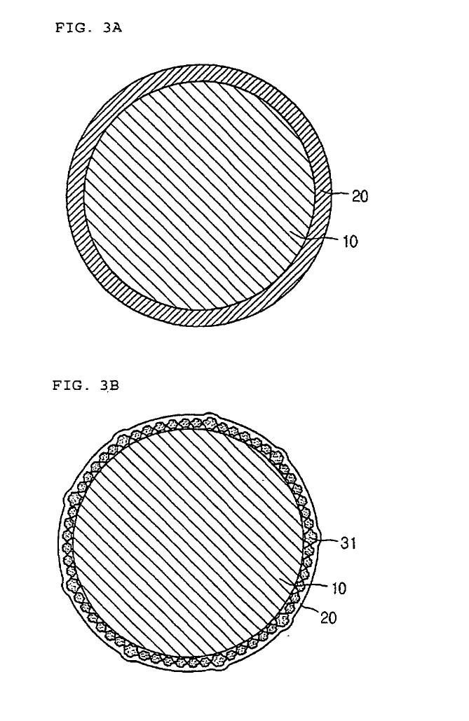

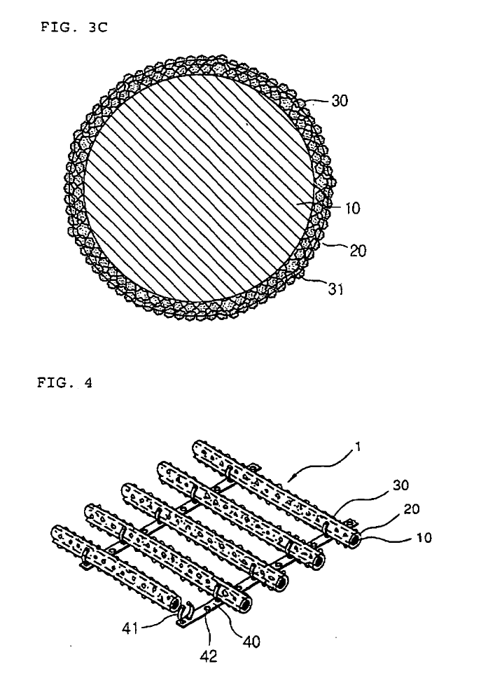

As shown in FIGS. 3A through 3C, the garnet layer 30 is formed by spraying the garnets twice under a predetermined pressure.

That is, as shown in FIG. 3A, the rod comprised of the reinforcing member 10 and the resin layer 20 is first prepared. A diameter of the rod may be about 9 mm.

Next, as shown in FIG. 33, in the initial hardening process of the resin layer 20, the garnets 31 are firstly sprayed on the resin layer 20 under a predetermined pressure such that they can be penetrated into the resin layer 20.

At this point, although the surface of the resin layer may be locally protruded but generally smooth.

Thereafter, as shown in FIG. 3C, the garnets 31 are secondly sprayed under a predetermined pressure such that the garnets 31 can be protruded above the surface of the resin layer 20.

In the second spray process, since the hardening process of the resin layer is quite progressed, the garnets 31 are not deeply buried in the resin layer 20. Since the garnets 31 sprayed in the first spray process are deeply buried in the resin layer 20, the garnets 31 sprayed in the second spray process are protruded above the surface of the resin layer 20, thereby formed a rough surface.

In the garnet layer forming process, the resin layer 20 is preferably maintained at a temperature of 60-80° C.

In the first spraying process, 30-45 Wt % of the garnets 31 is used. In the second spraying process, 55-70 Wt % of the garnets 31 is used.

Since the garnets 31 sprayed in the second spray process define the surface of the rod member 1, an amount of the garnets sprayed in the second spray process should be greater than that sprayed in the first spray process.

As an embodiment, when a diameter of the rod comprised of the reinforcing layer and the resin layer 20 is about 9 mm, an amount of the garnets sprayed in the first spray process is about 15 g/m and an amount of the garnet sprayed in the second spray process is about 25 g/m.

A method for making the rod member according to the present invention will be briefly described again hereinafter.

First, the rod-shaped reinforcing layer 10 is first formed. The reinforcing layer 10 may be formed of a material selected from the group consisting of consisting of a carbon fiber, a glass fiber and an aramid fiber.

The resin layer 20 is formed on an outer circumference of the reinforcing layer 10 to define the rod. The resin layer may be formed of a material selected from the group consisting of an epoxy resin, an acryl resin and a polyvinyl ester resin.

At this point, the reinforcing layer 10 is about 60-80 Wt % while the resin layer is about 20-40 Wt %.

In addition, in a state where the resin layer 20 is deposited, the garnets 31 are sprayed through the first and second spray processes.

At this point, the resin layer is maintained at a temperature of 60-80° C. The garnets 31 sprayed in the first spray process is about 30-45 Wt % while the garnets 31 sprayed in the second spray process is about 55-70 Wt % relative to the total weight of the garnet layer.

### EMBODIMENT

A rod-shaped aramid fiber is first prepared. Polyvinyl ester resin is formed on an outer surface of the aramid fiber, thereby defining a rod. Here, the aramid fiber is about 70 Wt % relative to the total weight of the rod while the polyvinyl ester resin is about 30 Wt % relative to the total weight of the rod.

A diameter of the rod comprised of the aramid fiber and the polyvinyl ester is about 9 mm.

In a state where the polyvinyl ester resin is maintained at a temperature of 70° C., garnets each having 300-800 μm are sprayed through first and second spray processes. The amount of the garnets sprayed in the first spray process is about 15 g/m while the amount o the garnets sprayed in the second spray process is about 25 g/m.

At this point, the pressure of the first spray process is about 1.02 N/mm² while that of the second spray process is about 1.02-5N/mm².

FIG. 4 shows a using state of the rod member according to the present invention.

As shown in FIG. 4, the rod member 1 is coupled to clip brackets 40 on which clips 41 and holes 42 are arranged at a predetermined distance from each other.

The clip 41 is used to couple the rod member 1 and the hole 42 is used to attach the clip bracket 41 to the structure.

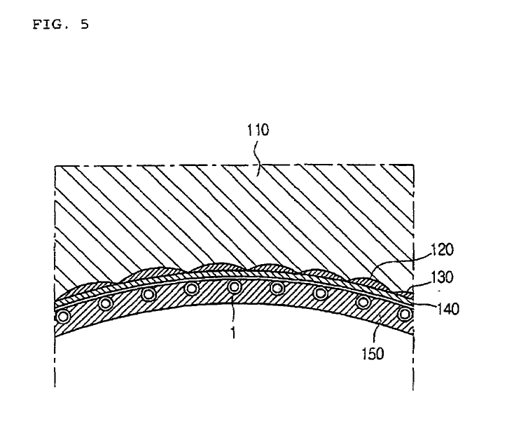

FIG. 5 shows a state where the rod member is applied to a structure.

When the inventive rod member 1 is used in maintenance/reinforcing construction method for a tunnel concrete structure, a damaged surface 120 of the concrete structure 110 is refined through a chipping process, after which a permeable primer layer 130 is formed through a permeable primer depositing process.

After the above, the aqueous acryl polymer mortal layer 140 is formed and the rod member 1 is coupled through the hole of the clip bracket 40.

Next, an aqueous acryl polymer mortal layer 150 is formed to be integral with the concrete structure with the damaged surface.

By the series of processes, the damaged structure can be easily maintained and remedied, thereby saving the costs and the processing time.

The inventive rod member may be used in place of an iron rod for the newly constructing structure as well as a damaged structure. Since the inventive rod member is light in weight compared with the iron rod and kept in custody for a long time. Furthermore, the inventive rod member has an advantage of being wet-resistible.

### INDUSTRIAL APPLICABILITY

The inventive rod member can be applied to a variety of construction/engineering structures.

1. A rod member comprising:
a rod-shaped reinforcing layer formed of a fiber;
a resin layer formed on an outer circumference of the reinforcing layer; and
a garnet layer formed in/on the resin layer.

2. The rod member according to claim 1, wherein the fiber is selected from the group consisting of a carbon fiber, a glass fiber and an aramid fiber.

3. The rod member according to claim 1, wherein the resin layer is formed of a material selected from the group consisting of an epoxy resin, an acryl resin and a polyvinyl ester resin.

4. The rod member according to claim 1, wherein the garnet layer is formed with a plurality of garnets each having a 300-800 μm size.

5. A rod member comprising:
a rod having a reinforcing member formed of an aramid fiber and a resin layer formed on an outer circumference of the reinforcing member; and
a garnet layer formed on an outer circumference of the rod,
wherein the garnet layer is formed with a plurality of garnets, some of the garnets being mixed in the resin layer and rest of the garnets being protruded above the resin layer.

6. The rod member according to claim 5, wherein a mass of the reinforcing member is about 60-80% of a mass of the rod.

7. The rod member according to claim 5, wherein the resin layer is formed of a material selected from the group consisting of an epoxy resin, an acryl resin and a polyvinyl ester resin.

8. A method for making a rod member, comprising the steps of:
forming a reinforcing member using a fiber;
forming a resin layer on an outer circumference of the reinforcing member to define a rod with the reinforcing member; and
forming a garnet layer on an outer circumference of the resin layer through first and second garnet spraying processes.

9. The method according to claim 8, wherein the fiber is selected from the group consisting of a carbon fiber, a glass fiber and an aramid fiber.

10. The method according to claim 8, wherein the resin layer is formed of a material selected from the group consisting of an epoxy resin, an acryl resin and a polyvinyl ester resin.

11. The method according to claim 8, wherein the garnet layer is formed with a plurality of garnets each having a 300-800 μm size.

12. The method according to claim 8, wherein the rod is formed with the 60-80 Wt % reinforcing member and the 20-40 Wt % resin layer.

13. The method according to claim 8, wherein in the step of forming the garnet layer, 30-45 Wt % garnets with respect to a whole weight of the garnet layer are sprayed in the first garnet spraying process and 55-70 Wt % garnets with respect to a whole weight of the garnet layer are sprayed in the second garnet spraying process.
